(19) United States
(12) Patent Application Publication
(10) Pub. No.: US 2005/0170152 A1
(43) Pub. Date: Aug. 4, 2005

(54) Plate

(76) Inventor: Helmut Moser, Bruchsal (DE)

Correspondence Address: SUGHRUE MION, PLLC, 2100 PENNSYLVANIA AVENUE, N.W., SUITE 800, WASHINGTON, DC, 20037, US

(21) Appl. No.: 10/505,522

(22) PCT Filed: Jan. 23, 2003
(86) PCT No.: PCT/EP03/00677

(30) Foreign Application Priority Data
Aug. 20, 2002 (DE) 102 38 054.6

(51) Int. Cl. B32B 3/00

(52) U.S. Cl. 428/195.1; 428/209; 428/690

(57) ABSTRACT

In a plate, in particular a motor vehicle licence plate, which comprises a carrier (1) of a plastically deformable material and an electroluminescence layer structure for forming at least one flat capacitor which has a base electrode (7), an insulating layer (15), a pigment layer (16) which lights up in operation and a transparent cover electrode (17), to improve the contactability of the electrodes of the flat capacitor it is provided that applied to the carrier (1) is a further insulating layer (3a) over which is arranged an electrically conducting layer (3b) from which the base electrode and at least one feed-in line (10), which is electrically separated from the base electrode, for the cover electrode of the at least one flat capacitor are produced.

The invention concerns a plate, in particular a motor vehicle licence plate, as set forth in the classifying portion of claim 1.

A plate of that kind is known for example from German utility model No 299 11 348.5. Described therein is a metal plate which is coated with an electroluminescence structure and which is not only a carrier but at the same time also a base electrode of the electroluminescence structure. That admittedly affords a very simple structure but it suffers from a number of disadvantages.

On the one hand such an arrangement cannot be used for plates in which the carrier comprises a non-conducting plastic material.

Further problems are involved in reliably electrically contacting the extremely thin, transparent cover electrode disposed on the top side of the electroluminescence structure. The alternating current which flows by way of an electroluminescence flat capacitor increases, the greater the surface area covered by that flat capacitor. Having regard to the size of a motor vehicle licence plate, serious difficulties are involved in feeding the required current into the extremely thin cover electrode in such a way that this does not result in excessively great current densities which can lead to the cover electrode being locally burnt through or vaporised. In addition it is necessary to ensure that, when contacting the cover electrode the dielectric layers which are disposed therebeneath are not pierced, which would result in a short-circuit and thus functional failure of the electroluminescence flat capacitor.

In addition the entire arrangement is exposed to extreme environmental influences with a high level of mechanical and chemical loading (severe vibration, corrosive environment, high moisture content and so forth). That also applies in particular for the current connection terminals of the two electrodes of the electroluminescence flat capacitor, at which no high and/or increasingly worsening transition resistances should occur.

Accordingly the object of the present invention is to provide a plate of the kind set forth in the opening part of this specification, in the production of which a carrier of metal or plastic material can be selectively used and in which at any event simple and reliable contacting of the electrodes of the flat capacitor, in particular the thin cover electrode, is guaranteed.

To attain that object the invention provides the features recited in claim 1. Those measures are based on the realisation that it is advantageous to forego the use of the carrier as the base electrode. That means that admittedly, the structural simplification known from the quoted state of the art is no longer enjoyed, but at the same time a series of advantages is also attained.

A first of those advantages is that the electrical conductivity of the carrier is no longer an important consideration so that, in the production of such a plate, it is possible to use either a metal carrier or a plastic carrier selectively and in a manner adapted to the respective situation of use.

Another important advantage is that not only one or more base electrodes of one or more flat capacitors but also at least one feed-in line can be produced in respective electrically mutually insulated relationship from the electrically conducting layer which initially covers the further insulating layer over the entire surface area, in which case the feed-in line, in the finished layer structure, is covered over from above by the thin cover electrode in such a way that there is an electrically well conducting contact. The feed-in line can be taken almost around the entire peripheral edge of the base electrode arrangement so as to afford an elongate narrow conductor strip, by way of which the current flowing through the flat capacitor arrangement can be fed into the cover electrode with a sufficiently low current density without the risk of damage.

It is particularly preferable for the further insulating layer used to be a plastic sheet or film which is applied to the carrier in a condition of adhering firmly thereto and which, on its side remote from the carrier, carries the electrically conducting layer, for example in the form of a copper coating, from which the desired conductor track structures can be produced by known etching procedures.

Preferably that plastic film has at least one tongue which projects beyond the edge of the carrier and on which the connection conductor tracks for the base electrode arrangement and the feed-in line are provided. The tongue can be folded over in the mounted condition on to the rear side of the carrier and there contacted, by means of one of the known processes.

A further aspect of particular significance is that both the electrically conducting layer from which the base electrode arrangement and the feed-in line are produced and also the extremely thin cover electrode are readily capable of also taking part in subsequent mechanical deformation, which is effected for example by a stamping or embossing operation, of the initially flat carrier, without that involving impairment of the operational capability of the electroluminescence arrangement.

In particular it is possible to emboss into the carrier from the rear depressions which provide that raised portions are produced on the side of the carrier which is towards the person viewing the arrangement, which raised portions are for example in the shape of symbols to be represented and are covered with a color which is opaque in relation to the light of the electroluminescence arrangement so that the symbols formed in that way appear dark in front of an illuminating background.

The overall arrangement can be covered with a further film or sheet which is moisture-tightly connected at the edges to the carrier and which protects the electroluminescence structures in relation to moisture and mechanical damage.

Advantageously, that protective cover may also include retroreflecting components so that, when the electroluminescence arrangement is switched off, under incident external light, a plate designed in that way has a high reflection capability.

These and further advantageous configurations of a plate according to the invention are set forth in the appendant claims.

The invention is described hereinafter by means of an embodiment with reference to the drawing in which:

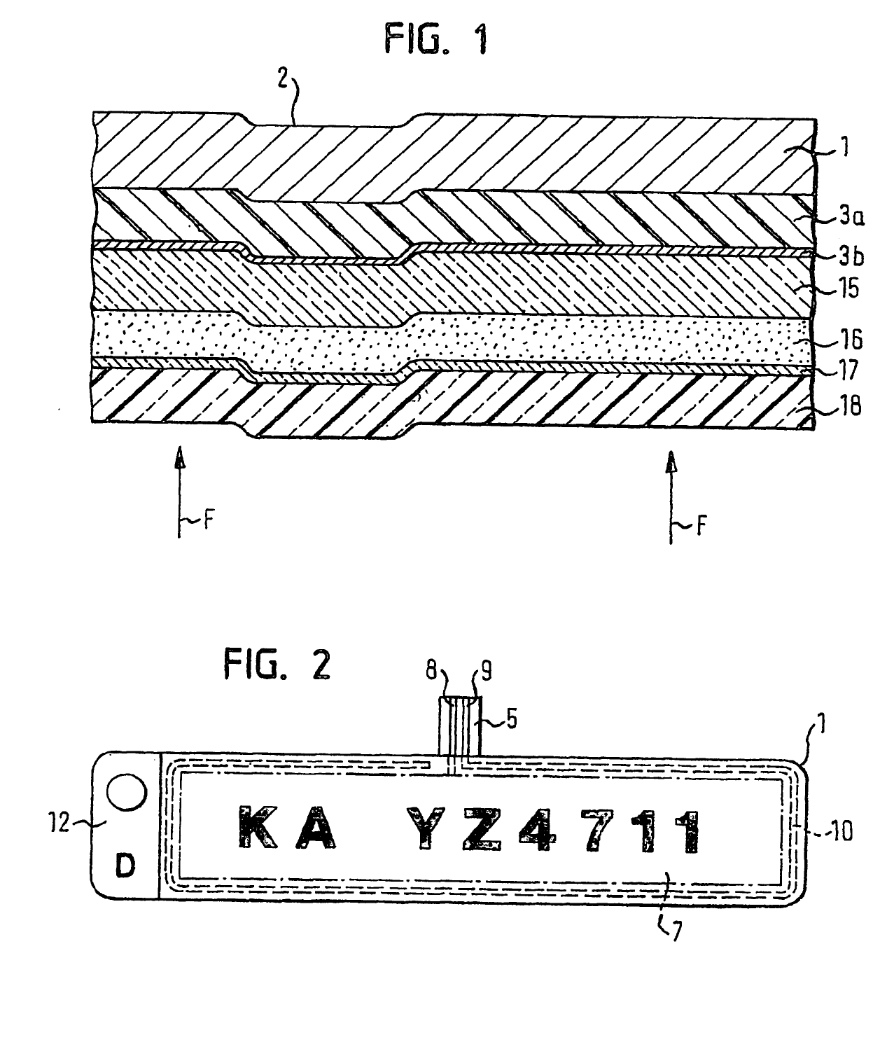

FIG. 1 is a highly diagrammatic view of a typical layer structure for a self-illuminating plate according to the invention, and

FIG. 2 is a diagrammatic plan view of a motor vehicle licence plate of that layer structure.

In FIG. 1 in which the arrows F show the main direction of view of the person viewing the arrangement, the individual layers are shown on a greatly enlarged scale. For the sake of clarity of the drawing individual ones of the layers which in actual fact are particularly thin are shown on a greatly enlarged scale.

Disposed ‘at the back’ in the viewing direction F, that is to say at the location most remote from the person viewing the arrangement, is the deformable carrier 1 which can comprise a metal or plastic plate member which is deformable by a mechanical embossing or stamping operation. In the illustrated embodiment the carrier 1 has a depression 2 which is embossed from the rear and which provides that a corresponding raised portion is to be found on its front side which is towards the person viewing the arrangement. It should be particularly pointed out that the deformation of the carrier 1, which leads to that depression 2 and further depressions and/or raised portions, does not have to be effected prior to application of the layer structure described in detail hereinafter. Rather, it is possible for the carrier 1 with the complete layer structure to be produced in a finished condition as a ‘blank’ which can then subsequently be mechanically stamped or embossed in any manner and/or deformed in any other fashion.

That is of significance in particular in regard to the production of motor vehicle licence plates in which firstly blanks of that kind are produced in large numbers by specific manufacturers and sold to the ‘plate makers’ who, upon customer order, after allocation of a specific motor vehicle registration, stamp or emboss that registration into the blank from the rear, in which case the raised regions on the front side are colored black. The plate described in the present application is readily suitable for that operating procedure.

Applied to the carrier 1 over the entire surface area thereof is an insulating plastic film or sheet 3a which on its front side towards the person viewing the arrangement is provided initially over its entire area with a layer 3b of a material which is a good electrical conductor, for example copper.

As can be seen in particular from FIG. 2 that plastic film 3a has a tongue 5 which is shown on a greatly enlarged scale in FIG. 2 and which projects beyond the outline contour of the carrier 1 and which is initially also coated over its surface area with an electrically conducting material 3b.

Two mutually separate and electrically insulated surface regions are produced from that electrically conducting coating, those surface regions being shown by dashed and dashed-dotted lines respectively in FIG. 2.

One of the two surface regions forms a base electrode 7 which covers almost the entire front face of the carrier 1 and defines the size and shape of the surface which lights up in operation of the finished structure. As will be seen the base electrode 7 is directly electrically conductingly connected to a connecting conductor 8 provided on the tongue 5.

Extending around the base electrode 7 is a feed-in line 10 which is connected to the connecting conductor 9 and which, as will be described in still greater detail hereinafter, serves for the power supply for the transparent cover electrode of the flat capacitor forming the electroluminescence structure.

Both the width of the feed-in line 10 and also the spacings thereof relative to the edge of the carrier 1 on the one hand and the edge of the base electrode 7 on the other hand are shown on a greatly enlarged scale in FIG. 2 for the sake of enhanced clarity of the drawing. In practice the edge of the base electrode 7 can extend substantially further to the edge of the carrier 1 so that virtually its entire front face which is towards the person viewing the arrangement is illuminated.

An exception from this is only formed by the region 12 which is shown entirely at the left in FIG. 2 and which involves the blue region which is provided on European licence plates, with the ring of stars and the nationality identification.

In accordance with the invention it is readily possible for that region also to be designed to be illuminated.

In that case the base electrode 7 is then extended by a corresponding distance towards the left. In that respect, a narrow space always still remains there so that the feed-in line 10 can extend around the base electrode 7.

As can also be seen from FIG. 1 the electrically conducting coating 3b is covered completely by an insulating layer 15 which forms a main part of the dielectric of the flat capacitor to be formed and which is preferably colored with a white pigment which admittedly itself does not light up but which reflects towards the viewer the light produced in operation by the pigment layer 16 covering it, and thus provides for a marked improvement in brightness.

The insulating layer 15 can be used in the production of the blank to produce the etching mask which covers the surface regions 7, 8, 9, 10 of the electrically conducting coating 3b of the plastic film 3a so that, in an etching step, only the intermediate spaces which remain free therebetween are etched away and thus the surface regions 7 and 8 on the one hand and the surface regions 9 and 10 on the other hand are electrically insulated from each other.

In comparison the pigment layer 16 preferably only covers the surface region of the base electrode 7 as in fact all other regions are not to be adapted to light up.

Prior to application of the extremely thin transparent cover electrode 17 (see FIG. 1), the part of the insulating layer 15 which covers the feed-in line 10 is removed so that the cover electrode 17 can involve intimate contact, providing good electrical conduction, with the feed-in line 10.

The purpose of that feed-in line is to feed in the alternating current which flows to the cover electrode 17, over as large a surface area as possible, in order to minimise local current densities. Otherwise, by virtue of the extremely small thickness of the cover electrode 17, there would be the risk of at least local damage due to burning or vaporisation because of an excessively high current density.

As already indicated the base electrode 7, the insulating layer 15, the pigment layer 16 and the transparent cover electrode 17 form a flat capacitor to which in operation an ac voltage for example of the order of magnitude of between 80 V and 100 V and of a frequency of the order of magnitude of 400 Hz can be applied in order to cause the pigment layer 16 to light up.

The overall arrangement is covered over its entire area by a transparent plastic film or sheet 18 which is connected to the carrier in moisture-tight relationship at the outside edges of the carrier in order to protect the flat capacitor from moisture and which can contain retroreflecting components.

The tongue 5 which projects upwardly in FIG. 2 can be provided at any other location on the carrier. In the mounted condition it is folded over rearwardly on to the rear side of the carrier 1 and can there be connected by soldering or crimping or another known contacting process to connecting lines which lead on further elsewhere or directly to the actuating device which produces the ac voltage required for operation of the self-illuminating licence plate, from the motor vehicle on-board dc voltage system.

In principle it is also possible to provide in the left-hand side region 12 a separate flat capacitor, the base electrode of which is separate from the base electrode 7 but which can have a common cover electrode with the other flat capacitor. The base electrode of that further flat capacitor then has to be passed out by way of its own connecting line (not shown) on the tongue 5 so that separate actuation is possible and each of the two regions can be switched on and off separately.

As an alternative to the above-discussed embodiment by way of example of the invention the plastic film 3a can also carry a plurality of electrically conducting coatings which are electrically insulated from each other by interposed insulating layers and from which mutually different electrically conducting regions, in particular connecting conductor tracks, are produced, in order to make it possible for more than two flat capacitors provided on the surface of the licence plate, which can be arranged in side-by-side relationship or one behind the other in the direction of view F also to be actuated separately from each other.

1. A plate, in particular a motor vehicle licence plate, which comprises a carrier (1) of a plastically deformable material and an electroluminescence layer structure for forming at least one flat capacitor which has a base electrode (7), an insulating layer (15), a pigment layer (16) which lights up in operation and a transparent cover electrode (17), characterised in that applied to the carrier (1) is a further insulating layer (3a) over which is arranged an electrically conducting layer (3b) from which the base electrode (7) and at least one feed-in line (10), which is electrically separated from the base electrode, for the cover electrode (17) of the at least one flat capacitor are produced.

2. A plate as set forth in claim 1 characterised in that the further insulating layer (3a) is a plastic film which is firstly covered throughout with an electrically conducting material on the side remote from the carrier (1).

3. A plate as set forth in claim 2 characterised in that the plastic film has at least one tongue (5) which projects beyond the carrier (1) and on which are provided connecting lines (8, 9) required for contacting of the base electrode (7) and the feed-in line (10).

4. A plate as set forth in claim 3 characterised in that the base electrode (7) and the feed-in line (10), which is electrically separate therefrom, of the at least one flat capacitor and the connecting lines (8, 9) which are connected to them are produced from the electrically conducting material by an etching process.

5. A plate as set forth in claim 2, characterised in that the electrically conducting material is copper.

6. A plate as set forth in claim 1, characterised in that the carrier (1) comprises metal.

7. A plate as set forth in claim 1, characterised in that the electroluminescence layer structure has a plurality of flat capacitors.

8. A plate as set forth in claim 7 characterised in that at least two of the flat capacitors are actuable independently of each other.

9. A plate as set forth in claim 7 characterised in that at least two of the flat capacitors have a common cover electrode (17).

10. A plate as set forth in claim 8 characterised in that at least two flat capacitors have mutually electrically separated base electrodes, by means of which they are actuable independently of each other.

11. A plate as set forth in claim 7 characterised in that provided for separate cover electrodes of at least two flat capacitors is a respective separate feed-in line.

12. A plate as set forth in claim 3, characterised in that each of the connecting conductor lines (8, 9) is connected by a solder connection to a wire of a power supply line.

13. A plate as set forth in claim 3, characterised in that each of the connecting conductor lines (8, 9) is connected by a crimp connection to a wire of a power supply line.

14. A plate as set forth in claim 1, characterised in that at least the side of the carrier (1), which carries the electroluminescence layer structure, has an insulating transparent cover (18) for mechanically protecting the flat capacitor arrangement.

15. A plate as set forth in claim 14 characterised in that the transparent cover (18) is moisture-tight.

16. A plate as set forth in claim 14 characterised in that the transparent cover (18) is formed by a plastic film.

17. A plate as set forth in claim 14, characterised in that the transparent cover (18) contains retroreflecting components.

18. A plate as set forth in claim 16 characterised in that the plastic film forming the transparent cover (18) is connected in moisture-tight relationship to projecting side regions of the carrier.

19. A plate as set forth in claim 1, characterised in that provided in at least one flat capacitor is at least one color filter for changing the spectrum of the light color predetermined by the pigments of the pigment layer (16).

20. A plate as set forth in claim 1, characterised in that there is provided a layer for reflecting the light emitted by the pigment layer (16) in the direction of the base electrode (7).

21. A plate as set forth in claim 20 characterised in that the insulating layer (15) serves at the same time as a reflecting layer.
